(19) United States
(12) Patent Application Publication
(10) Pub. No.: US 2025/0300728 A1
(43) Pub. Date: Sep. 25, 2025

(54) FIBER DIAGNOSTICS ON A COHERENT OPTICAL SUPERVISORY CHANNEL

(71) Applicant: Nokia Solutions and Networks Oy, Espoo (FI)

(72) Inventors: Mikael Mazur, Summit, NJ (US); Nicolas K. Fontaine, New Providence, NJ (US); Roland Ryf, Aberdeen Township, NJ (US); David Neilson, Old Bridge, NJ (US)

(73) Assignee: Nokia Solutions and Networks Oy, Espoo (FI)

(21) Appl. No.: 19/084,874

(22) Filed: Mar. 20, 2025

Related U.S. Application Data
(60) Provisional application No. 63/568,936, filed on Mar. 22, 2024.

(51) Int. Cl. H04B 10/071; H04B 10/25; H04B 10/40

(52) U.S. Cl. CPC H04B 10/071; H04B 10/25; H04B 10/40

(57) ABSTRACT

A system and method are disclosed, in which data in an optical supervisory channel is transmitted from a first node of an optical fiber network to a second node of the optical fiber network and received in a coherent optical receiver at the second node of the optical fiber network. From a receiver output signal responsive to the received data, there is extracted at least one measure of phase variation and/or of signal attenuation on the optical fiber network between the first and second nodes.

### CROSS REFERENCE TO RELATED APPLICATION

This application claims the benefit of Provisional Application Ser. No. 63/568,936, filed in the US Patent and Trademark Office on Mar. 22, 2024 (the “'936 Application”) and incorporates by reference herein the entire disclosure of the '936 Application.

### TECHNICAL FIELD

The present disclosure relates to systems, methods, and apparatus for remotely sensing faults, disturbances, and the like in fiber-optic networks.

### ART BACKGROUND

Proposals for leveraging the existing fiber-optic network infrastructure to support distributed sensing have attracted interest because they offer the possibility of more robust network operation. Additionally, they offer the possibility to collect valuable data by sensing phenomena such as vehicular traffic, earthquakes, flooding, fires, and landslides.

Two principal sensing schemes have been proposed for communication networks: Distributed Acoustic Sensing (DAS) and transceiver-based sensing. DAS is based on Rayleigh backscattering. It is very sensitive to mechanical effects and also allows for precise localization of events. However, DAS typically works only for a single span, it may produce more data than can be processed effectively, it may require dedicated bandwidth in the transmission channel, and it is generally very costly.

Transceiver-based sensing uses the real-time readouts produced by coherent digital signal processing to measure phase and state of polarization (SOP) effects integrated over the transmitted link. Transceiver-based sensing is scalable, and it can be implemented without sacrificing spectral efficiency. Base of implementation makes transceiver-based sensing an attractive choice for quickly covering an entire network with sensors. For some applications, for example, SOP sensing alone may be sufficient for network monitoring and fault detection. However, transceiver-based sensing does not provide precise fault location. It also lacks access to the information close to the fault, because the network traffic has to be terminated to access the sensing data. In some applications, there may be a further drawback that the coherent transceivers operating over a fiber do not belong to the operator of the fiber. This could make it difficult for the operator to access the information about the state of that fiber.

A problem still facing network designers is how to integrate per-span sensing into the network without sacrificing available bandwidth.

### SUMMARY

We have devised a new approach that can integrate per-span sensing into the network without sacrificing available bandwidth. In embodiments, our approach combines network management, data transmission, and fiber sensing into a single system.

In our new approach, a coherent optical supervisory channel (C-OSC) transceiver is enabled to perform per-span forward sensing, exemplarily phase and polarization sensing. In embodiments, the C-OSC transceiver is further enabled to perform distributed acoustic sensing using Rayleigh backscattering over a relatively narrow bandwidth channel at the same time as the forward sensing.

With our approach, sensing can be directly integrated into the network on a per-span level. Because our approach can provide a relatively large bandwidth for sensing, it has the potential for sensing data to be extracted directly from intermediate nodes using the added bandwidth of the C-OSC to transmit real-time sensing data.

Moreover, an optical supervisory channel, in current practice, is used to control the network equipment. Consequently, the C-OSC will typically belong to the operators of the fiber and amplifier systems. Hence, such operators would be able to directly utilize the C-OSC to determine the state of their equipment.

Accordingly, the present disclosure relates, in a first aspect, to a system comprising a first transceiver circuitry at a first node of an optical fiber network and a second transceiver circuitry at a second node of the optical fiber network, and further comprising a digital processing circuitry. The first transceiver circuitry comprises a transmitter configured to transmit data in an optical supervisory channel to the second transceiver circuitry. The second transceiver circuitry comprises a coherent optical receiver configured to receive data in the supervisory channel from the first transceiver circuitry and to produce a receiver output signal. The digital processing circuitry is configured to extract, from the receiver output signal, at least one measure of phase variation and/or of signal attenuation on the network between the first node and the second node.

In embodiments, the second transceiver circuitry comprises a transmitter configured to transmit data in an optical supervisory channel to the first transceiver circuitry; the first transceiver circuitry comprises a coherent receiver configured to receive data in the supervisory channel from the second transceiver circuitry and produce a receiver output signal; and the first node further comprises a digital processing circuitry configured to extract, from the output signal of the receiver at the first node, at least one measure of phase variation and/or of signal attenuation on the network between the nodes.

In embodiments, the transmitter of the first transceiver circuitry comprises a dual polarization IQ modulator. In further embodiments, the first transceiver circuitry comprises a polarization multiplexed digital modulation circuit configured to provide a digitally modulated signal to the transmitter of the first transceiver circuitry for transmission.

In embodiments, the first transceiver circuitry is further configured to transmit a DAS probe signal toward the second node of the optical fiber network on the supervisory channel; and the first transceiver circuitry further comprises a receiver circuitry configured to receive backscattered light from the DAS probe signal and to produce a DAS output signal in response to receiving said backscattered light from the DAS probe signal. In various embodiments, the second transceiver circuitry may be further configured to transmit a DAS probe signal toward the first node on the supervisory channel; and the second transceiver circuitry may further comprise a receiver circuitry configured to receive backscattered light from the DAS probe signal sent out toward the first node and to produce a DAS output signal in response thereto.

In embodiments, the first transceiver circuitry further comprises a single-sideband modulation circuit configured to modulate the DAS probe signal, and the receiver circuitry for backscattered light from the DAS probe signal sent toward the second node comprises a heterodyne receiver. In embodiments, the heterodyne receiver may be a dual-polarization heterodyne receiver, In embodiments, the single-sideband modulation circuit may be configured to modulate the DAS probe signal at an intermediate RF frequency.

In embodiments, the first transceiver circuitry is configured to transmit the data simultaneously with the DAS probe signal, such that the data and the DAS probe signal are carried optically on the same supervisory channel, but are separated from each other in RF frequency. For example, the optical supervisory channel may be a coherent optical supervisory channel that is generated at baseband, and a tailored waveform for DAS sensing may be modulated and centered at a selected intermediate frequency.

In embodiments, the first node further comprises a circuitry configured to extract, from the DAS output signal, information indicative of times and/or of locations of disturbances on the optical fiber network between the first and second nodes. In further embodiments, the second transceiver circuitry comprises a transmitter configured to transmit data to the first node on the supervisory channel; the first transceiver circuitry comprises a coherent receiver configured to receive data in the supervisory channel from the second transceiver circuitry and to produce a receiver output signal in response thereto; and the first node further comprises a digital processing circuitry configured to extract, from the receiver output signal, at least one measure of phase variation and/or of signal attenuation on the network between the first and second nodes.

In another aspect, the present disclosure relates to an optical transceiver apparatus, comprising an optical modulator configured to modulate an RF signal onto an optical channel of an optical fiber network; and a processor circuit configured to generate the RF signal and to provide it to the optical modulator. The processor circuit is configured to generate the RF signal and to provide the RF signal to the optical modulator such that the RF signal comprises a data signal and a DAS probe signal separated in RE frequency from the data signal; and the modulator is configured to modulate both the data signal and the DAS probe signal onto the same optical channel.

In embodiments, the modulator is a dual polarization IQ modulator.

In embodiments, the processor circuit comprises a single-sideband modulator for generating the DAS probe signal. In further embodiments, the optical transceiver apparatus further comprises a coherent receiver configured to receive polarization-multiplexed signals on the optical channel. In still further embodiments, the optical modulator and the coherent receiver are jointly integrated components of an analog integrated optics module.

In embodiments, the apparatus further comprises a dual-polarization heterodyne receiver configured to receive signals on the optical channel.

In yet another aspect, the present disclosure relates to a method, comprising: transmitting data in an optical supervisory channel from a first node of an optical fiber network to a second node of the optical fiber network; receiving the transmitted data in a coherent optical receiver at the second node of the optical fiber network and producing a receiver output signal in response to the received data; and by digital processing, extracting from the receiver output signal at least one measure of phase variation and/or of signal attenuation on the optical fiber network between the first and second nodes.

In embodiments, the transmitting of data comprises modulating the data onto the optical supervisory channel with a dual polarization IQ modulator. In further embodiments, the data modulated onto the optical supervisory channel is provided to the dual polarization IQ modulator as a polarization multiplexed digitally modulated radiofrequency signal.

In embodiments, the method further comprises transmitting a DAS probe signal from the first node toward the second node on the optical supervisory channel concurrently with the transmitting of data in the optical supervisory channel; and the method further comprises, at the first node, receiving backscattered light from the DAS probe signal and producing a DAS output signal in response thereto. In further embodiments, the method further comprises, at the first node, extracting information from the DAS output signal that is indicative of times and/or of locations of disturbances on the optical fiber network between the first and second nodes. In still further embodiments, the extracting of information from the DAS output signal comprises extracting information by phase-sensitive optical time-domain reflectometry.

In embodiments, the method further comprises generating the DAS probe signal as a single-sideband-modulated radiofrequency signal, and wherein the backscattered light from the DAS probe signal is received with a heterodyne receiver. In further embodiments, the DAS probe signal is modulated at an intermediate RF frequency, and the heterodyne receiver is a dual-polarization heterodyne receiver.

### BRIEF DESCRIPTION OF THE DRAWINGS

FIG. 1 is a block diagram of an example transceiver circuit suitable for performing the sensing operations described herein. The transceiver circuit is shown in the context of a demonstration network in which a loopback returns the outgoing signal to the transceiver for reception and processing after the signal has traversed a test link. It should be noted in this regard that the C-OSC channel would typically be operated in unidirectional mode,

FIG. 2 is a flowchart illustrating an example method that may be practiced using, e.g., the example transceiver circuit of FIG. 1.

FIG. 3 shows constellation diagrams for received QPSK signals received in respective X-and Y-polarization channels in an experimental demonstration of a system of the kind shown in FIG. 1, in which a fiber span passed through a metropolitan area.

FIG. 4 is a plot of phase noise measured during the demonstration of FIG. 3 integrated over a duration of one second at 2:00 a.m. (lower curve) and at 8:00 a.m. (upper curve) on a Monday morning. In the figure, phase noise is plotted as power spectral density (PSD) versus frequency. Comparing the night-time curve to the rush-hour curve shows a large increase in noise.

FIG. 5 is a trace of signal intensity versus distance, obtained by phase-sensitive optical frequency-domain reflectometry (PS-OFDR) performed during the demonstration of FIG. 3. The inset in FIG. 5 is a zoom-in of approximately the first 3 km of fiber. The inset shows three strong reflections at the fiber input.

FIG. 6 is a graph of phase variance of backscattered light as a function of distance, measured during the demonstration of FIG. 3. It can be seen in the figure that the vast majority of the accumulated environmental noise occurs within the first 15 km of fiber.

FIG. 7 is a graph of phase variance versus time of day in hours on a 24-hour clock, measured during the demonstration of FIG. 3. The graph is a composite of curves corresponding to the phase variance as measured at respective distances of 3 km, 6 km, 12 km, 25 km, and 38 km along the fiber. The position marked “0” on the horizontal axis corresponds to midnight, Sunday night. A large increase in noise seen at about 5 a.m. is well aligned with the onset of subway service in the metropolitan area.

### INCORPORATION BY REFERENCE

The paper by M. Mazur et al., titled “Transoceanic Phase and Polarization Fiber Sensing using Real-Time Coherent Transceiver,” and published in 2022 Optical Fiber Communications Conference and Exhibition (OFC), San Diego, CA, USA, 2022, pp. 1-3, hereinafter cited as “Mazur 2022”, describes various principles and techniques that may be useful in practicing the subject matter of the present disclosure. Mazur 2022 is hereby incorporated herein by reference in its entirety.

### DETAILED DESCRIPTION OF EMBODIMENT

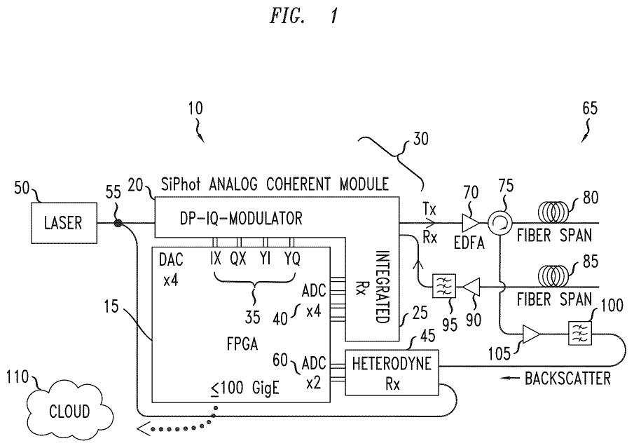

FIG. 1 is a schematic block diagram illustrating our approach in an embodiment that is to be understood as exemplary and non-limiting. As shown in the figure, a transceiver circuit 10 includes a field-programmable gate array (FPGA) IS. A digital signal processor (DSP) for performing the digital-domain stages of signal generation and conditioning, coding and decoding, and modulation and demodulation is embodied in the FPGA but not indicated explicitly in the figure. The transceiver circuit 10 includes a coherent modulator 20 and coherent receiver 25 which may be integrated components of an analog integrated optics module 30, as shown in the figure. Although embodiments of our approach that transmit on a single polarization channel may be useful for at least some purposes, the coherent modulator 20 in a preferred embodiment is a dual polarization (DP) IQ modulator, as shown in FIG. 1.

With further reference to FIG. 1, a series 35 of four digital-to-analog converters (DACs) are seen to be embodied in the FPGA, two for polarization channel X and two for polarization channel Y. Thus, as indicated by the labels attached to the DACs in the figure, one pair of DACs (IX, QX) provides the respective in-phase (I) and quadrature (Q) analog signals to the DP-IQ modulator in the X channel, and the other pair of DACs (YI, YQ) provides the respective I and Q analog signals in the Y channel.

In a conventional network, DACs such as those discussed above could provide the modulation signal to the IQ modulator 20 for the supervisory data carried by the C-OSC. In embodiments of our new approach, the same supervisory data may be carried by the C-OSC, but, in addition, at least some of the supervisory data may also be treated as a probe signal for transceiver-based sensing. That is, noise and signal impairments in the stream of supervisory data that is transmitted forward to a coherent receiver at a destination node can be analyzed to obtain information about conditions along the transmission path that may affect the transmitted signal. In this regard, at least, DP-IQ transmission and dual polarization coherent detection are advantageous, because they permit information to be obtained about four degrees of freedom of the transmitted signal, i.e., information about the amplitude and phase in each of the two polarization channels.

Because the sensing data is embodied in the forward-propagating signal, we also refer to coherent transceiver-based sensing as “forward sensing” in the present discussion.

Turning again to FIG. 1, it will be seen that a series 40 of four analog-to-digital converters (ADCs) are embodied in the FPGA for receiving the analog output signals in the respective XI, XQ, YI, and YQ channels and converting them to digital signals for digital signal processing.

In some embodiments, the C-OSC may be used for both forward sensing and DAS sensing, whereas other embodiments may be limited to only one type of sensing or the other. In the example of FIG. 1, both forward sensing and DAS sensing are enabled. For DAS sensing, the outgoing probe signal is generated and transmitted by the same hardware that generates and transmits the C-OSC signal, and it is interleaved with the outgoing C-OSC signal. Thus, in particular, a single dual polarization modulator 20 may be used to produce an interleaved waveform that can achieve both transceiver-based and DAS sensing.

With further reference to FIG. 1, it will be seen that a dedicated receiver 45 is provided for the backscattering signals, i.e., for the backscattered portion of the DAS probe signals. Because the sensing information is obtained from probe light that returns to the node from which it was transmitted, we also refer to DAS sensing as “reverse sensing” in the present discussion.

One example of a type of receiver suitable for receiving the backscattering signals is a dual polarization heterodyne receiver 45, as indicated in the figure. A heterodyne receiver may be useful, for example, when the DAS probe signal is generated as a single-side-band (SSB) modulated waveform.

A typical dual-polarization heterodyne receiver 45 includes two balanced photo-detectors and a polarization beam splitter, which are not shown in FIG. 1. A transmitter laser 50, shown in FIG. 1, provides the optical carrier for the C-OSC signal. An optical tap SS from the transmitter laser, exemplarily a 3 dB tap, provides the local oscillator (LO) for the heterodyne receiver 45.

A series 60 of two further ADCs sample the respective output data streams from the heterodyne receiver for input to the FPGA.

It is noteworthy in this regard that when digital SSB modulation is used for the DAS probe signal, there is no need for an acousto-optic modulator to frequency-shift the local oscillator for the heterodyne receiver.

The transceiver of FIG. 1 is shown connected to a test network 65 that was used for an experimental demonstration. As shown, the transmitted signal output was amplified by an erbium-doped fiber amplifier (EDFA) 70 and connected to the input port of a circulator 75 before being launched over a fiber link 80. At the end of the fiber link 80, about 45 km away, a loopback 85, including another EDFA 90, was implemented to return the signal to the receiver end 25 of the transceiver 30. Backscattered light entering the circulator 75 in the upstream direction was directed to the heterodyne receiver 45. Bandpass filters 95 and 100, respectively, are shown in FIG. 1 just after EDFA 90 in the return path to the receiver end of the transceiver and just after EDFA 105 in the backscatter path to the heterodyne receiver.

After initial filtering and decimation, the backscattering signal may, for example, be packed into remote direct memory access (RDMA) frames and directly transferred to the memory of a graphics processing unit (GPU). The DAS traces can be processed in real time using standard OFDR processing methods. By way of example, OFDR processing capabilities can be placed locally in the case, e.g., of continuous DAS operation, or they can be offloaded to the cloud 110 for, e.g., the use of on-demand resources.

Any of various waveforms may be used for forward sensing. As noted, a polarization-multiplexed waveform is not a requirement, but it may be particularly advantageous, not least because of the wealth of monitor information it can potentially provide. In particular, any of various constellation formats may be desirable for at least some applications. One useful example uses polarization-multiplexed quadrature phase shift keying (PM-QPSK) symbols.

In operation, a C-OSC signal is generated at baseband, and a tailored waveform for DAS sensing based, e.g., on optical frequency domain reflectometry (OFDR) is modulated and centered at a selected intermediate frequency (IF). In the example described below, we selected an IF of 750 MHz. However, we observed that in our prototype implementation, the IF could readily be increased op to 2.25 GHz, or even greater frequencies, to support more data bandwidth if desired.

The receiver DSP may be operated, for example, at a typical rate of 125 MHz (8 times parallelism). The DSP operations include the standard processing steps of filtering and decimation to 2-folded oversampling, dynamic equalization for polarization demultiplexing, phase tracking and performance evaluation.

In addition, phase and polarization sensing are enabled by adding additional real-time logic blocks to the DSP implementation. These blocks support real-time extraction of the equalizer taps, holding the (inverse) polarization rotation performed by the channel, and use of registers to count the applied phase and frequency offsets. Registers may be built into the DSP to dynamically reconfigure the averaging time and readout speed. The maximum achievable readout speed would generally be limited by the DSP clock rate.

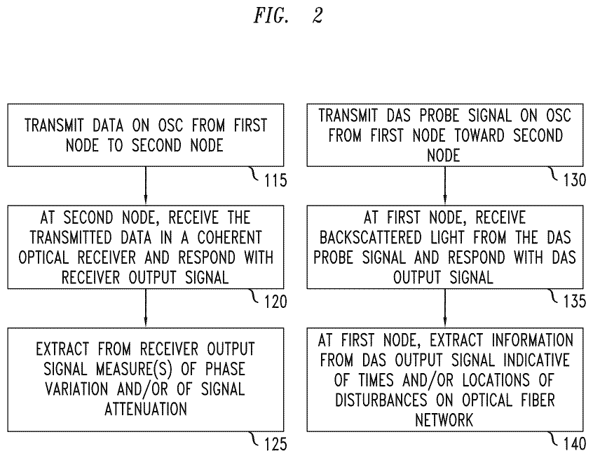

FIG. 2 is a flowchart illustrating an example method that may be practiced using, e.g., the example transceiver circuit of FIG. 1. According to the method of FIG. 2, data is transmitted 115 in an optical supervisory channel from a first node of an optical fiber network to a second node of the optical fiber network. The transmitted data is received 120 in a coherent optical receiver at the second node of the optical fiber network, and a receiver output signal is produced in response to the received data. Digital processing is used to extract 125, from the receiver output signal, at least one measure of phase variation and/or of signal attenuation on the optical fiber network between the first and second nodes. In embodiments, the transmitting of data may comprise modulating the data onto the optical supervisory channel with a dual polarization IQ modulator. For example, the data modulated onto the optical supervisory channel may be provided to the dual polarization IQ modulator as a polarization multiplexed digitally modulated radiofrequency signal.

As shown in FIG. 2, a DAS probe signal may additionally be transmitted 130 from the first node toward the second node on the optical supervisory channel concurrently with the transmitting of data in the optical supervisory channel. Backscattered light from the DAS signal may be received 135 at the first node, and a DAS output signal may be produced in response to the received backscattered light. Information may be extracted 140 from the DAS output signal that is indicative of times and/or of locations of disturbances on the optical fiber network between the first and second nodes. In embodiments, the extracting of information from the DAS output signal may, e.g., comprise extracting information by phase-sensitive optical time-domain reflectometry.

In embodiments, the DAS probe signal may be generated, e.g., as a single-sideband-modulated radiofrequency signal, and the backscattered light from the DAS probe signal may be received, e.g., with a heterodyne receiver. For example, the DAS probe signal may be modulated at an intermediate RF frequency, and the heterodyne receiver may be a dual-polarization heterodyne receiver.

### EXAMPLE

I. System. We arranged a prototype transceiver in a test network, substantially as illustrated in FIG. 1. The basic building block of the prototype was an FPGA (AMD ZU48DR) connected to an analog integrated optics module to form the optical transceiver. A laser operating at 1565 nm was used to place the OSC channel at the upper edge of the C-band.

The FPGA system had integrated DACs and ADCs operating at 10 GS/s and 5 GS/s, respectively.

The transmitted C-OSC data waveform, which was generated at baseband, consisted of 1 GBd PM-QPSK symbols at a raw (i.e., neglecting overhead for forward error correction) bit rate of 4 Gbit/s.

The real-time transmitter DSP operated at 250 MHz clock rate and implemented pulse shaping using a root-raised cosine filter with 10% roll-off in addition to bit-to-symbol mapping. To simulate a data signal, the X/Y-polarization bits were drawn from a PRBS 23 pseudorandom number sequence and a PRBS 31 pseudorandom number sequence, respectively.

In addition to the generated baseband data, a tailored waveform for DAS sensing based on OFDR was modulated and centered at an IF frequency of 750 MHz. The DAS probe bandwidth was 250 MHz. It was modulated as a single-side-band (SSB) modulated waveform.

The receiver DSP operated at 125 MHz (8 times parallelism) and consisted of standard processing steps including filtering and decimation to 2-folded oversampling, dynamic equalization for polarization demultiplexing, phase tracking and performance evaluation.

The backscattered light extracted from the circulator was amplified and detected via a dual-polarization heterodyne receiver. The receiver bandwidth was 2.5 GHz, and a 3 dB tap from the transmitter laser was used as local oscillator (LO).

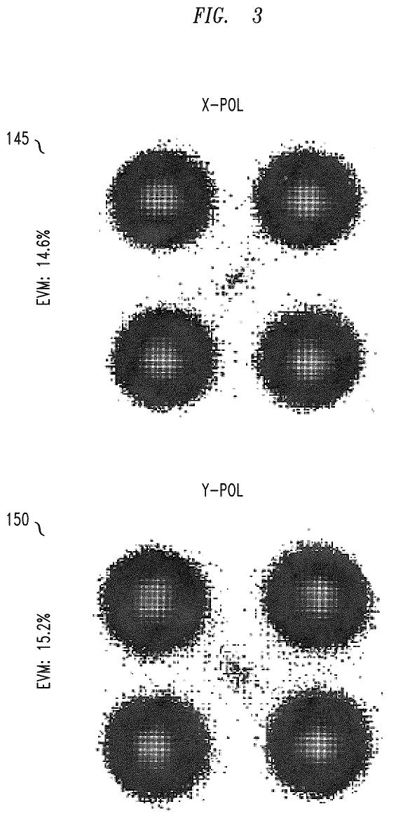

II. Demonstration. A system as described above was deployed to include a 45-km fiber passing through a portion of downtown Tokyo and including a loop-back link for a total terrestrial link length of 90 km. To evaluate the performance of the real-time coherent transceiver, received QPSK constellation diagrams for the X-and Y-polarization channels were obtained. The constellation diagrams are shown in FIG. 3 for X-polarization 145 and for Y-polarization 150.

We monitored the performance using real-time digital signal processing to provide error vector magnitude (EVM) calculations. The real-time DSP engine processed the incoming symbols at a parallelization degree of 8. The resulting EVM was 14.6% for the X-polarization channel and 15.4% for the Y-polarization channel. Long-time measurements showed an EVM variation of up to 2%, which we currently attribute to system dynamics.

We used the real-time sensing outputs from the transceiver to perform integrated link characterization (technically two times the link due to the loop-back). The resulting measured phase noise is shown in FIG. 4. The figure compares the phase noise 155 at 2 a.m. Monday morning with the phase noise 160 at 8 a.m. the same day. A large difference in the amount of phase noise between the two observation times is visible in the figure. It should be noted in this regard that the DSP performance did not change, and that the fluctuations were well within the tracking capabilities of our implementation. The source of the added noise was determined to be phase modulations from the fiber, and not the laser.

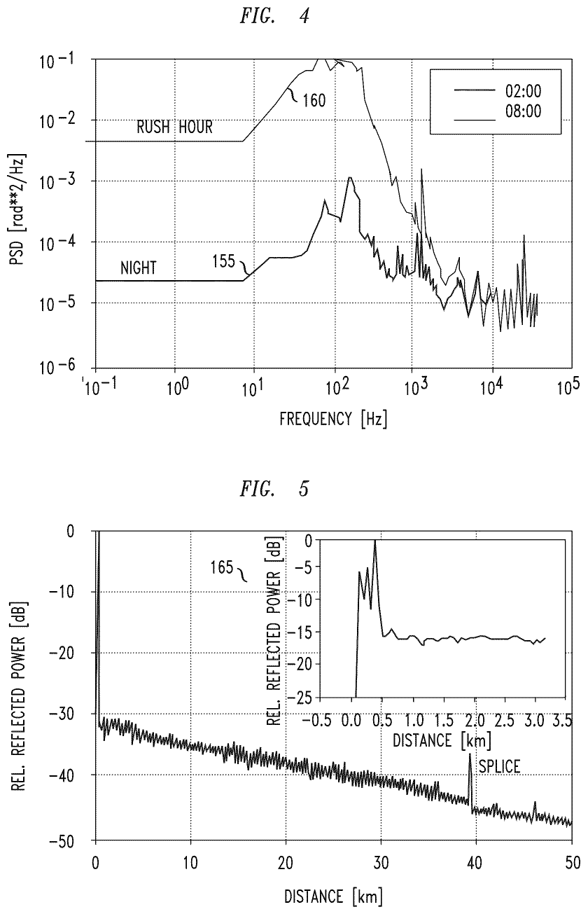

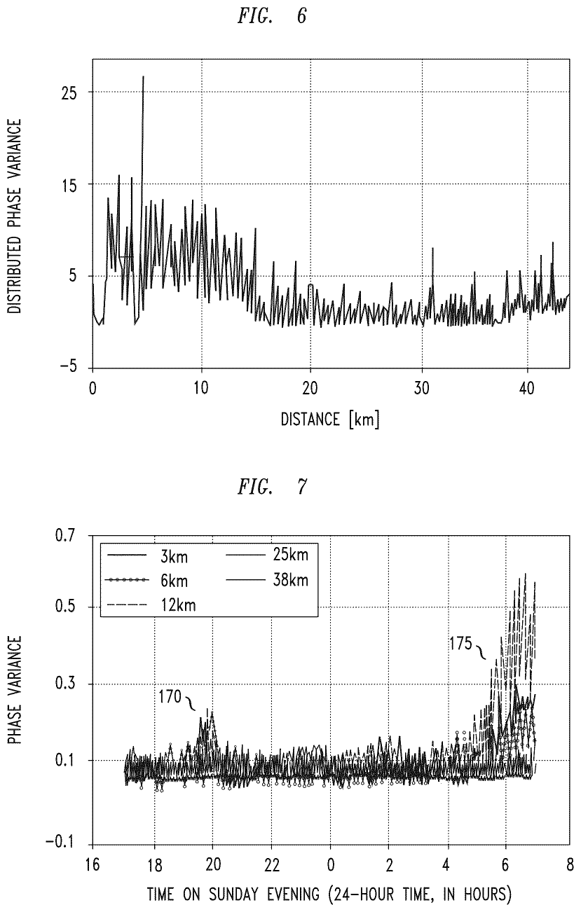

Fiber loss measurements obtained by phase-sensitive optical frequency-domain reflectometry (PS-OFDR) are shown in FIG. 6. (It should be noted in this regard that similar data would be obtainable using regular intensity-only optical time domain reflectometry, i.e., OTDR, (measurements.) A zoom-in 165 of approximately the first 3 km of fiber is shown in the inset to FIG. 5. Three strong reflections at the fiber input are clearly visible in the inset.

The PS-OFDR system was used to extract phase variations along the link. The result is shown for a one-minute average in FIG. 6. It is evident from the figure that the bulk of the phase noise is added within, approximately, the first 15 km of the link. The likely cause is routing of the fiber in highly exposed ducts under Tokyo, making it susceptible to vibrations.

This proposed explanation is supported by the long-term trace of phase variance versus time shown in FIG. 7. The figure is a composite of five plots that respectively visualize the results for a step length/gauge length of about 50 m at distances of 3, 6, 12, 25, and 38 km from the transmitter. Examination of the figure shows that the fiber is quiet for the most part, with a small bump 170 between 6 km and 12 km observed around 8 p.m. Sunday evening. The Monday morning rush 175 is clearly visible, with a drastic increase in phase noise observed for the first part of the fiber link, starting around 5 a.m. The onset at 5 a.m. matches well with the operational hours of the Tokyo metro and train network.

III. Summary. We demonstrated a new real-time coherent optical supervisory (C-OSC) channel prototype capable of Gigabit/s transmission and distributed fiber sensing. The demonstrated system uses digital frequency interleaving of a 1-GBd dual-polarization quadrature phase shift keying signal and a tailored waveform enabling optical frequency domain reflectometry via heterodyne detection.

We demonstrated the system capabilities over a 45-km-long loop-back link (90 km total distance) in downtown Tokyo. We used a combination of forward transceiver sensing and distributed acoustic sensing (DAS) based on Rayleigh backscattering.

Our result shows how advanced per-span sensing capabilities may be integrated in the optical network without inducing loss in system throughput.

Depending on the span of interest, the C-OSC can be implemented by any of various types of equipment with different sensing capabilities ranging from polarization/phase-based sensing for network monitoring and outage prevention to advanced DAS for environmental sensing and smart-city applications.

We claim:

1. A system, comprising:
a first transceiver circuitry at a first node of an optical fiber network, and a second transceiver circuitry at a second node of the optical fiber network, wherein:
the first transceiver circuitry comprises a transmitter configured to transmit data in an optical supervisory channel to the second transceiver circuitry;
the second transceiver circuitry comprises a coherent optical receiver configured to receive data in the supervisory channel from the first transceiver circuitry and to produce a receiver output signal; and
the system further comprises a digital processing circuitry configured to extract, from the receiver output signal, at least one measure of phase variation and/or of signal attenuation on the network between the first node and the second node.

2. The system of claim 1, wherein the transmitter of the first transceiver circuitry comprises a dual polarization IQ modulator.

3. The system of claim 2, wherein the first transceiver circuitry comprises a polarization multiplexed digital modulation circuit configured to provide a digitally modulated signal to the transmitter of the first transceiver circuitry for transmission.

4. The system of claim 1, wherein:
the first transceiver circuitry is further configured to transmit a DAS probe signal toward the second node of the optical fiber network on the supervisory channel; and
the first transceiver circuitry further comprises a receiver circuitry configured to receive backscattered light from the DAS probe signal and to produce a DAS output signal in response to receiving said backscattered light from the DAS probe signal.

5. The system of claim 4, wherein the first transceiver circuitry further comprises a single-sideband modulation circuit configured to modulate the DAS probe signal, and wherein the receiver circuitry for backscattered light from the DAS probe signal sent toward the second node comprises a heterodyne receiver.

6. The system of claim 4, wherein the first transceiver circuitry is configured to transmit the data simultaneously with the DAS probe signal, such that the data and the DAS probe signal are carried optically on the same supervisory channel, but are separated from each other in RF frequency.

7. The system of claim 4, wherein the first node further comprises a circuitry configured to extract, from the DAS output signal, information indicative of times and/or of locations of disturbances on the optical fiber network between the first and second nodes.

8. An optical transceiver apparatus, comprising:
an optical modulator configured to modulate an RF signal onto an optical channel of an optical fiber network; and
a processor circuit configured to generate the RF signal and to provide it to the optical modulator;
wherein the processor circuit is configured to generate the RF signal and to provide the RF signal to the optical modulator such that the RF signal comprises a data signal and a DAS probe signal separated in RF frequency from the data signal;
and wherein the modulator is configured to modulate both the data signal and the DAS probe signal onto the same optical channel.

9. The optical transceiver apparatus of claim 8, wherein the modulator is a dual polarization IQ modulator.

10. The optical transceiver apparatus of claim 8, wherein the processor circuit comprises a single-sideband modulator for generating the DAS probe signal.

11. The optical transceiver apparatus of claim 8, further comprising a coherent receiver configured to receive polarization-multiplexed signals on the optical channel.

12. The optical transceiver apparatus of claim 11, wherein the optical modulator and the coherent receiver are jointly integrated components of an analog integrated optics module.

13. The optical transceiver apparatus of claim 8, further comprising a dual-polarization heterodyne receiver configured to receive signals on the optical channel.

14. A method, comprising:
transmitting data in an optical supervisory channel from a first node of an optical fiber network to a second node of the optical fiber network;
receiving the transmitted data in a coherent optical receiver at the second node of the optical fiber network and producing a receiver output signal in response to the received data; and
by digital processing, extracting from the receiver output signal at least one measure of phase variation and/or of signal attenuation on the optical fiber network between the first and second nodes.

15. The method of claim 14, wherein the transmitting of data comprises modulating the data onto the optical supervisory channel with a dual polarization IQ modulator.

16. The method of claim 15, wherein the data modulated onto the optical supervisory channel is provided to the dual polarization IQ modulator as a polarization multiplexed digitally modulated radiofrequency signal.

17. The method of claim 14, further comprising:
transmitting a DAS probe signal from the first node toward the second node on the optical supervisory channel concurrently with the transmitting of data in the optical supervisory channel; and
at the first node, receiving backscattered light from the DAS probe signal and producing a DAS output signal in response thereto.

18. The method of claim 17, further comprising, at the first node, extracting information from the DAS output signal that is indicative of times and/or of locations of disturbances on the optical fiber network between the first and second nodes.

19. The method of claim 18, wherein the extracting of information from the DAS output signal comprises extracting information by phase-sensitive optical time-domain reflectometry.

20. The method of claim 17, further comprising generating the DAS probe signal as a single-sideband-modulated radiofrequency signal, and wherein the backscattered light from the DAS probe signal is received with a heterodyne receiver.
